(19) United States
(12) Patent Application Publication
(10) Pub. No.: US 2020/0210985 A1
(43) Pub. Date: Jul. 2, 2020

(54) CROSS-BORDER ACCOUNT SPLITTING METHOD BASED ON INTELLIGENT INTERNALLY-CONNECTED ELECTRONIC ACCOUNT, ACCOUNT SPLITTING PLATFORM, AND PAYMENT PLATFORM

(71) Applicant: HANGZHOU PINGPONG INTELLIGENT TECHNICAL CO., LTD, Hangzhou, Zhejiang (CN)

(72) Inventors: Yu CHEN, Zhejiang (CN); Wei XIONG, Zhejiang (CN); Peng CHEN, Zhejiang (CN); Ning WANG, Zhejiang (CN); Shuai LU, Zhejiang (CN)

(73) Assignee: HANGZHOU PINGPONG INTELLIGENT TECHNICAL CO., LTD, Hangzhou, Zhejiang (CN)

(21) Appl. No.: 16/616,396

(22) PCT Filed: May 17, 2018
(86) PCT No.: PCT/CN2018/087273

§ 371 Date: Nov. 22, 2019

(30) Foreign Application Priority Data
May 23, 2017 (CN) 201710369597.0

(51) Int. Cl. G06Q 20/22; G06Q 20/10; G06Q 20/36; G06Q 40/02

(52) U.S. Cl. CPC G06Q 20/227; G06Q 40/02; G06Q 20/3676; G06Q 20/102

(57) ABSTRACT

A cross-border account splitting method based on an intelligent internally-connected electronic account, an account splitting platform, and a payment platform. The account splitting method comprises the steps of: receiving a registration request of a client and assigning and feeding back an intelligent internally-connected electronic account to the client; associating information items carried in the registration request, the intelligent internally-connected electronic account and etc, so as to form a mapping relationship; receiving a withdrawing request of the client, and determining a target intelligent internally-connected electronic account, a target store, a target bank account, a target overseas master account and a target domestic master account according to the information items carried in the withdrawing request and the mapping relationship; transferring a cross-border transaction amount of the target store to the target overseas master account, and entering a virtual transaction account equivalent to the cross-border transaction amount into the intelligent internally-connected electronic account; and computing an actual split amount according to the virtual transaction amount in the target intelligent internally-connected electronic account, and transferring the actual split amount to the target bank account by means of the target domestic master account, and resetting the target intelligent internally-connected electronic account. Merchants can withdraw from their cross-border transactions without creating accounts on counters of overseas branches of overseas banks.

The present application claims priority to Chinese Patent Application No. 201710369597.0, titled “METHOD FOR CROSS-BORDER FUND-SPLITTING BASED ON INTELLIGENT INTERNAL-CONNECTION ELECTRONIC ACCOUNT, FUND-SPLITTING PLATFORM, AND PAYMENT PLATFORM”, filed on May 23, 2017 with the State Intellectual Property Office of the People's Republic of China, which is incorporated herein by reference in its entirety.

### FIELD

The present disclosure relates to the technical field of financial payment, and in particular to a method for cross-border fund-splitting based on an intelligent internal-connection electronic account, a fund-splitting platform, and a payment platform.

### BACKGROUND

In recent years, e-commerce has an increasing influence on economy and society in various countries under development of world economic integration and globalization. Traditional foreign trade has developed poorly in China since 2008, and an average annual growth is slowed to below 10%, while cross-border e-commerce has developed rapidly. According to statistics of the Ministry of Commerce, the cross-border e-commerce transaction in China increases rapidly in years 2008 to 2016, during which an average annual growth rate of the cross-border e-commerce transaction is close to 30%. It is estimated that a scale of the cross-border e-commerce transactions in China would reach 8.8 trillion RMB Yuan in 2018. Small and medium enterprises in China use cross-border e-commerce to enter the international market, and there is a great and far-reaching significance in increasing an international market share of China's products, expanding foreign trade marketing networks, creating new export competitive advantages, transforming traditional international trade transactions, promoting China's foreign trade industrial transformation and industrial upgrading, and improving the competitiveness of China's foreign trade in the international market.

Rapid development of cross-border e-commerce requires a reliable means of cross-border payment as a foundation. After Chinese merchants earn revenues from sales in an overseas e-commerce platform, they need to withdraw funds in foreign currency, so as to complete a commercial production process. For cross-border e-commerce in export, payment is fulfilled in foreign-card acquiring business. That is, a domestic merchant sells wares to an overseas consumer via a cross-border e-commerce platform, and a payment institution receives foreign currency and settles exchange for the domestic merchant after the consumer pay. There is a problem of regional difference for the cross-border payment, where the transaction fund of a user on the overseas e-commerce platform needs to be withdrawn to a domestic bank account of the user before being used. It is necessary that the user applies for an overseas bank account. The transaction fund of the user on the overseas e-commerce platform is firstly transferred to the overseas bank account of the user, and then transferred to the domestic bank account from the overseas bank account. In actual operation, overseas banking institutions require the merchant to visit overseas branch offices him or herself, due to financial supervision, for opening the overseas bank accounts. Most small merchants in China have never gone abroad, and it requires a lot of time, efforts and money. Therefore, it is difficult to withdrawn the above-mentioned foreign currency fund, hindering development of the domestic cross-border e-commerce business. Some merchants have no choice but to transfer money through illegal private banks, which has both financial and legal risks. Additionally, there are constraints from the e-commerce platform accounting period, and from an auditing and management process of settlement and sales of exchange at the bank. Thereby, the payment process is complex, efficiency is low, and account period is long. Generally, it takes 6 to 23 work days to receive the fund. A long and inefficient process of capital clearing and settlement results in great financial pressure on the cross-border merchants, brings risks on exchange rate, seriously affects utilization efficiency of funds, and increases operation risks of the cross-border merchants.

### SUMMARY

A method for cross-border fund-splitting, a fund-splitting platform based on an intelligent internal-connection electronic account, a fund-splitting system, and a payment platform are provided according to embodiments of the present disclosure.

In a first aspect, a method for cross-border fund-splitting based on an intelligent internal-connection electronic account is provided according to an embodiment, including:
receiving a registration request from a client, assigning an intelligent internal-connection electronic account to a corresponding user, and feeding the intelligent internal-connection electronic account back to the client, where the registration request carries identity information of the user, store information, and a bank account;
associating the intelligent internal-connection electronic account, the identity information of the user, the store information, and the bank account, with a pre-acquired overseas main account and a pre-acquired domestic main account, to form a mapping relationship;
receiving a withdrawal request from the client, and determining a target intelligent internal-connection electronic account, a target store, a target bank account, a target overseas main account, and a target domestic main account, according to the mapping relationship and an information item carried by the withdrawal request, where the information item carried by the withdrawal request includes at least one of the intelligent internal-connection electronic account, the identity information of the user, the store information, or the bank account;
transferring a cross-border transaction amount of the target store into the target overseas main account, and recording a virtual transaction fund that is equal to the cross-border transaction amount into the target intelligent internal-connection electronic account, or, recording a virtual transaction fund that is equal to a predetermined withdrawal amount into the target intelligent internal-connection electronic account when there is the predetermined withdrawal amount in the withdrawal request; and
calculating an actual fund-splitting amount based on the virtual transaction fund in the target intelligent internal-connection electronic account, transferring the actual fund-splitting amount into the target bank account from the target domestic main account, and clearing the target intelligent internal-connection electronic account.

In an embodiment, the actual fund-splitting amount is transferred into the target bank account from the target domestic main account, on the target overseas main account receiving the cross-border transaction amount of the target store and before the target domestic main account receiving the cross-border transaction amount.

In an embodiment, the actual fund-splitting amount is transferred into the target bank account from the target domestic main account, after the target overseas main account receiving the cross-border transaction amount of the target store and the target domestic main account receiving the cross-border transaction amount.

In an embodiment, the domestic main account is mapped to the intelligent internal-connection electronic account, the identity information of the user, the store information, the bank account, and the pre-acquired overseas main account, through one or both of a statistic binding relationship and a dynamic binding relationship.

In an embodiment, the domestic main account is mapped to the intelligent internal-connection electronic account, the identity information of the user, the store information, the bank account, and the pre-acquired overseas main account through the dynamic binding relationship; and determining the target domestic main account in determining the target intelligent internal-connection electronic account, the target store, the target bank account, the target overseas main account, and the target domestic main account, according to the mapping relationship and an information item carried by the withdrawal request, includes: selecting one from domestic main accounts that are in the dynamic binding relationship, of the mapping relationship, as the target domestic main account, and switching the target domestic main account to be mapped to other information items through the static binding relationship.

In a second aspect, a fund-splitting platform based on an intelligent internal-connection electronic account is provided according to an embodiment, including:
an assignation module, configured to receive a registration request from a client, assign an intelligent internal-connection electronic account to a corresponding user, and feed the intelligent internal-connection electronic account back to the client, where the registration request carries identity information of the user, store information and a bank account;
an association module, configured to associate the intelligent internal-connection electronic account, the identity information of the user, the store information, the bank account, with a pre-acquired overseas main account and a pre-acquired domestic main account, to form a mapping relationship;
a lookup module, configured to receive a withdrawal request from the client, and determine a target intelligent internal-connection electronic account, a target store, a target bank account, a target overseas main account, and a target domestic main account, according to the mapping relationship and an information item carried by the withdrawal request, where the information item carried by the withdrawal request includes at least one of the intelligent internal-connection electronic account, the identity information of the user, the store information, or the bank account;
an recording module, configured to record a virtual transaction fund, which is equal to a cross-border transaction amount transferred into the target overseas main account, into the target intelligent internal-connection electronic account, or record a virtual transaction fund, which is equal to a predetermined withdrawal amount in the withdrawal request, into the target intelligent internal-connection electronic account;
a transfer module, configured to calculate an actual fund-splitting amount based on the virtual transaction fund, and transfer the actual fund-splitting amount into the target bank account from the target domestic main account; and
a clearing module, configured to clear the target intelligent internal-connection electronic account.

In an embodiment, the transfer module transfers the actual fund-splitting amount into the target bank account from the target domestic main account, on the target overseas main account receiving the cross-border transaction amount of the target store and before the target domestic main account receiving the cross-border transaction amount.

In an embodiment, the transfer module transfers the actual fund-splitting amount into the target bank account from the target domestic main account, after the target overseas main account receiving the cross-border transaction amount of the target store and the target domestic main account receiving the cross-border transaction amount.

In an embodiment, the domestic main account is mapped to the intelligent internal-connection electronic account, the identity information of the user, the store information, the bank account, and the pre-acquired overseas main account, through one or both of a statistic binding relationship and a dynamic binding relationship.

In a third aspect, a cross-border fund-splitting system based on an intelligent internal-connection electronic account is provided according to an embodiment, including a client, a fund-splitting platform, a cross-border e-commerce platform, and a financial platform, where:
the client is connected in network communication with the cross-border e-commerce platform and the fund-splitting platform, and the fund-splitting platform is further connected in network communication with the financial platform;
the fund-splitting platform receives a registration request from the client, assigns an intelligent internal-connection electronic account to a corresponding user, and feeds the intelligent internal-connection electronic account back to the client, where the registration request carries identity information of the user, store information, and a bank account;
the fund-splitting platform further associates the intelligent internal-connection electronic account, the identity information of the user, the store information, and the bank account, with a pre-acquired overseas main account and a pre-acquired domestic main account, to form a mapping relationship;
the cross-border e-commerce platform receives a withdrawal request from the client, and sends the withdrawal request to the fund-splitting platform, where an information item carried by the withdrawal request includes at least one of the intelligent internal-connection electronic account, the identity information of the user, the store information, or the bank account;
the fund-splitting platform further determines a target intelligent internal-connection electronic account, a target store, a target bank account, a target overseas main account, and a target domestic main account, according to the mapping relationship and the information item carried by the withdrawal request, and feeds the target store and the target overseas main account to the cross-border e-commerce platform;
the cross-border e-commerce platform further communicates with the financial platform, and transfers a cross-border transaction amount of the target store into the target overseas main account;
the fund-splitting platform further records a virtual transaction fund, which is equal to the cross-border transaction amount transferred into the target overseas main account, into the target intelligent internal-connection electronic account, or record a virtual transaction fund that is equal to a predetermined withdrawal amount into the target intelligent internal-connection electronic account when there is the predetermined withdrawal amount in the withdrawal request;
the fund-splitting platform further calculates an actual fund-splitting amount based on the virtual transaction fund, transfers the actual fund-splitting amount to the target bank account from the target domestic main account, and clears the target intelligent internal-connection electronic account.

In an embodiment, the fund-splitting platform includes:
an assignation module, configured to receive the registration request from the client, assign the intelligent internal-connection electronic account to the corresponding user, and feed the intelligent internal-connection electronic account back to the client;
an association module, configured to associate the intelligent internal-connection electronic account, the identity information of the user, the store information, and the bank account, with the pre-acquired overseas main account and the pre-acquired domestic main account, to form the mapping relationship;
a lookup module, configured to receive the withdrawal request from the client, and determine the target intelligent internal-connection electronic account, the target store, the target bank account, the target overseas main account, and the target domestic main account, according to the mapping relationship and the information item carried by the withdrawal request;
an recording module, configured to record the virtual transaction fund, which is equal to the cross-border transaction amount transferred into the target overseas main account, into the target intelligent internal-connection electronic account, or record the virtual transaction fund, which is equal to the predetermined withdrawal amount in the withdrawal request, into the target intelligent internal-connection electronic account;
a transfer module, configured to calculate the actual fund-splitting amount based on the virtual transaction fund, and transfer the actual fund-splitting amount into the target bank account from the target domestic main account; and
a clearing module, configured to clear the target intelligent internal-connection electronic account.

In an embodiment, the transfer module transfers the actual fund-splitting amount into the target bank account from the target domestic main account, on the target overseas main account receiving the cross-border transaction amount of the target store and before the target domestic main account receiving the cross-border transaction amount.

In an embodiment, the transfer module transfers the actual fund-splitting amount into the target bank account from the target domestic main account, after the target overseas main account receiving the cross-border transaction amount of the target store and the target domestic main account receiving the cross-border transaction amount.

In an embodiment, the domestic main account is mapped to the intelligent internal-connection electronic account, the identity information of the user, the store information, the bank account, and the pre-acquired overseas main account, through one or both of a statistic binding relationship and a dynamic binding relationship.

In a fourth aspect, a payment platform integrated with the aforementioned fund-splitting platform is provided according to an embodiment.

In the method for cross-border fund-splitting according to the aforementioned embodiment, in a case that the user submits the cross-border withdrawal request to the cross-border e-commerce platform, the target intelligent internal-connection electronic account, the target store, the target bank account, the target overseas main account and the target domestic main account are firstly determined based on the mapping relationship and the information item carried by the withdrawal request. Then, the cross-border transaction amount of the target store is first settled to the target overseas main account. Afterwards, the virtual transaction fund equal to the cross-border transaction amount is recorded into the target intelligent internal-connection electronic account. Finally, the virtual transaction fund is settled to the target bank account from the target domestic main account. On one hand, it is not necessary for the user engaged in cross-border e-commerce to visit an overseas branch counter of an overseas bank to open an overseas bank account. On the other hand, there is a star-type mapping relationship formed between the stores and the user, and funds can be collected from multiple platforms and multiples stores via one intelligent internal-connection electronic account. Overseas transfer and overseas collection are linked to each other through a single platform, providing a simple and efficient process.

Further, in a case that a balance in the target domestic main account is adequate, payment may be advanced from the target domestic main account in response to the cross-border withdrawal request from the user. Thereby, arrival term of the payment is shortened.

### BRIEF DESCRIPTION OF THE DRAWINGS

FIG. 1 is a flow chart of a method for cross-border fund-splitting;

FIG. 2 is a schematic diagram of composition of an ID of an intelligent internal-connection electronic account;

FIG. 3 is a diagram of a mapping relationship;

FIG. 4 is a schematic diagram of a fund-splitting platform according to an embodiment; and

FIG. 5 is a schematic diagram of a cross-border fund-splitting system according to another embodiment.

### DETAILED DESCRIPTION

Hereinafter the present disclosure is further described in detail via embodiments in conjunction with the drawings.

### First Embodiment

A method for cross-border fund-splitting based on an intelligent internal-connection electronic account is provided in this embodiment. By designing an intelligent internal-connection electronic account, an overseas main account and a domestic main account, it is not necessary for the user to visit an overseas branch counter of an overseas bank to open an overseas bank account. The user can achieve domestic collection and withdrawal of a cross-border transaction amount from a cross-border e-commerce platform.

Following prerequisites are required prior to cross-border fund-splitting for an operator of the cross-border fund-splitting. An overseas main account and a domestic main account are registered. It is necessary for the operator to register the overseas main account and the domestic main account at a branch counter of an overseas bank and a branch counter of a domestic bank. In addition, in order to meet demands of different users and different requirements of cross-border e-commerce platforms, the operator may register multiple overseas main accounts and multiple domestic main accounts at branches of multiple overseas banks and multiple domestic banks.

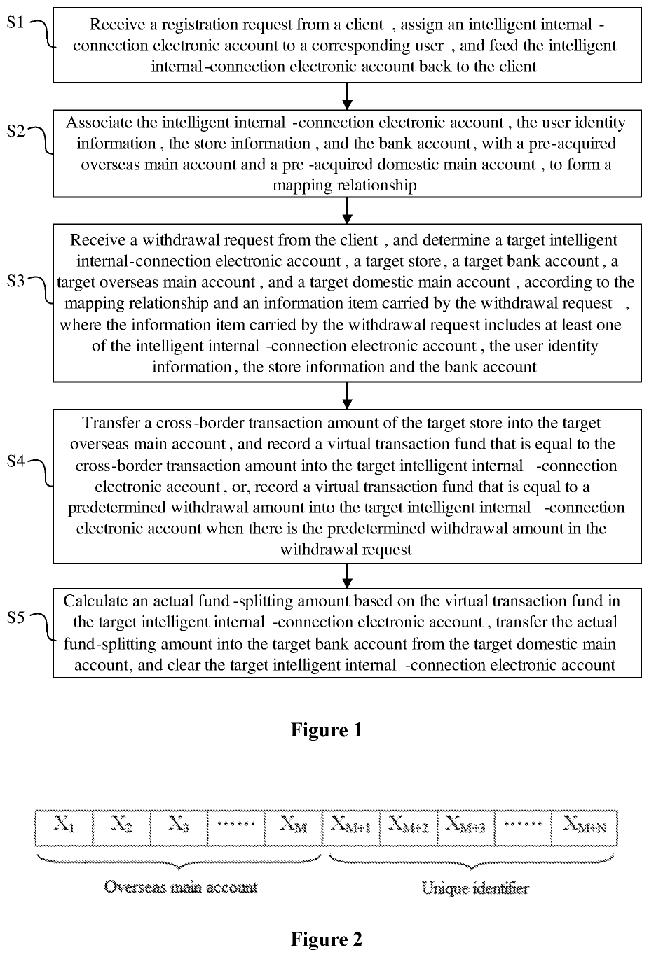

After the aforementioned overseas main account and domestic main account are successfully registered, withdrawal of the cross-border transaction amount from the cross-border e-commerce platform may be achieved. In one embodiment, the method may include steps S1 to S5, and a flow chart thereof is as shown in FIG. 1.

In step S1, a registration request is received from a client, an intelligent internal-connection electronic account is assigned to a corresponding user, and the intelligent internal-connection electronic account is fed back to the client.

The user registers the intelligent internal-connection electronic account in a fund-splitting platform in advance. An amount of an overseas transaction of the user may be transferred to a domestic bank account of the user via the fund-splitting platform by using the intelligent internal-connection electronic account. A principle of assigning the intelligent internal-connection electronic account is as follows. The registration request carries identity information of the user, store information (including account information of a store), bank account, and other information items. After receiving the registration request, the fund-splitting platform first examines at least one of the above information items, for example, the identity information of the user. The intelligent internal-connection electronic account is not assigned to the corresponding user until the examination is passed.

It should be noted that the “corresponding user” in “an intelligent internal-connection electronic account is assigned to a corresponding user” refers to a user to which the identity information in the registration request belongs.

Each intelligent internal-connection electronic account is provided with a unique identifiable ID. In practice, it is the ID of the intelligent internal-connection electronic account that is fed back to the client.

In one embodiment, a schematic diagram of composition of the ID of the intelligent internal-connection electronic account is as shown in FIG. 2. The ID includes M characters plus N characters, and M and N are positive integers greater than 1. The former M characters are an overseas main account code, and the latter N characters are a unique identification code. Each character of the N-character unique identification code is a letter or a number, that is, each character of the N-character unique identification code may be any of 26 lowercase English letters, 26 uppercase English letters, or 10 Arabic numerals. Thereby, a total amount of intelligent internal-connection electronic accounts that can be supported by one overseas main account is 62^{N}. In a case that the registration request is approved, one intelligent internal-connection electronic account that has not been assigned to other users is randomly selected from the total amount of intelligent internal-connection electronic accounts, and then assigned.

For example, assuming M=16 and N=6, the intelligent internal-connection electronic account is totally 22 characters. The former 16 characters represent a corresponding overseas main account code, and the latter 6 characters represent its own characteristics and are configured to distinguish different users. Thereby, the maximum number of users that can be supported by the overseas main account code is 62⁶=5.68*10¹⁰. In case of more users, there may be more characters in the unique identification code, that is, N is increased so as to increase the quantity of the supported users. Therefore, the total N characters may be set according to the quantity of users.

Generally, a user often runs multiple stores on different e-commerce platforms according to actual needs, and a binding relationship between the user and the multiple stores is a star-type mapping relationship. Domestic withdrawal of the cross-border transaction amount from the stores bound to the user is achieved through the star-type mapping relationship, and thereby cross-border collection from multiple stores and multiple platforms is achieved.

In one embodiment, one intelligent internal-connection electronic account is assigned to the user in order to improve resource utilization. In one embodiment, it is determined whether the identity information of the user carried by the registration request belongs to a same user. In case of positive determination, the same intelligent internal-connection electronic account is assigned to the user, and collection from multiple stores and multiple platforms is achieved by such intelligent internal-connection electronic account.

In practice, it is necessary to set a login password or other protection measures for the intelligent internal-connection electronic account. In order to further strengthen security, the user may be required to set a login password through the client when the intelligent internal-connection electronic account is fed back to the client. During usage, the user may log in via the intelligent internal-connection electronic account and the set login password.

In step S2, the intelligent internal-connection electronic account, identity information of the user, the store information, and the bank account, are associated with a pre-acquired overseas main account and a pre-acquired domestic main account, to form a mapping relationship.

Each internal-connection electronic account is bound to a corresponding overseas main account, and the overseas main account that is correspondingly bound is the overseas main account in the ID of such virtual account. The store information and a domestic bank account operated by each user are mapped to said user. In one embodiment, the fund-splitting platform may create a mapping table, and the identity information of the user, the intelligent internal-connection electronic account, the overseas main account, the domestic main account, the store information of the user on each cross-border e-commerce platform, and the domestic bank account of the user, are associated to form the mapping relationship. The mapping relationship is recorded into the mapping table. During usage, the mapping table is directly queried based on any known information item, and all the other information items can be obtained.

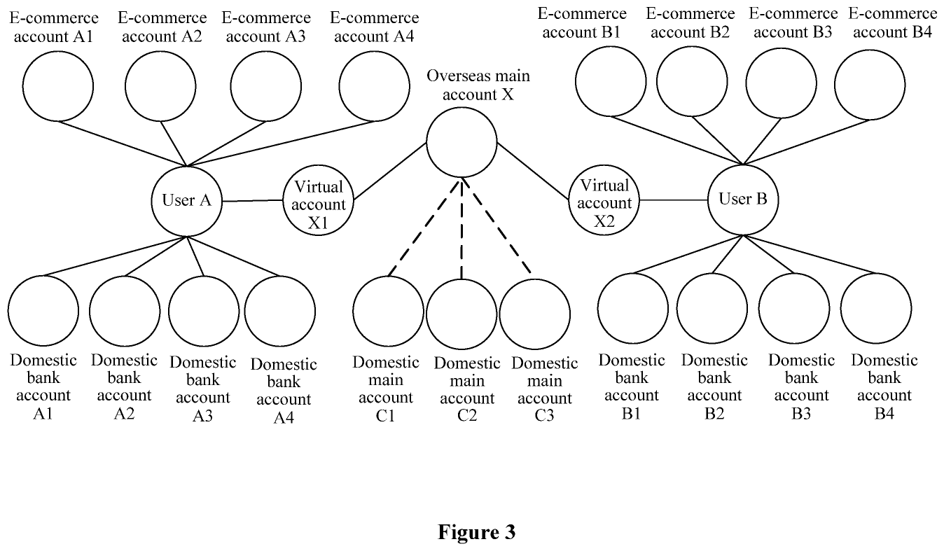

In one embodiment, the mapping relationship may be a static binding relationship or/and a dynamic binding relationship. The static binding relationship refers to that a binding relationship between two information items bound to each other is fixed during usage. The dynamic binding relationship refers to that a binding relationship between two information items bound to each other may be dynamically changed during usage. In one embodiment, the mapping relationship of information items is shown in FIG. 3. In FIG. 3, a solid line represents the static binding relationship, and a dashed line represents the dynamic binding relationship. In this embodiment, the mapping relationship between the overseas main account and the domestic main account is set as the dynamic binding relationship, and the dynamic binding relationship may be switched to the static binding relationship and switched back in a case that a set condition is satisfied. For example, the binding relationship between the user and the corresponding information items of the user is the dynamic binding relationship in a case the user does not withdraw any fund. In a case that the user withdraws a fund, the dynamic binding relationship between the user and other information items is switched to the static binding relationship according to a determined target domestic main account. In a case that the user finishes the withdrawal, the static binding relationship is automatically switched to the dynamic binding. Thereby, switching between the dynamic binding and the static binding is achieved.

Assignation of the intelligent internal-connection electronic account is achieved through the steps S1 and S2. After the user obtains the intelligent internal-connection electronic account, the user may submit a modification request to the fund-splitting platform through the client, in a case that the user needs to modify any information item corresponding to the user. The fund-splitting platform may modify the mapping table correspondingly after receiving the modification request, and feed a result of modification back to the client. The registered intelligent internal-connection electronic account itself cannot be modified. The intelligent internal-connection electronic account can be cancelled, and a new intelligent internal-connection electronic account may be applied for.

In the step S3, a withdrawal request is received from the client, and a target intelligent internal-connection electronic account, a target store, a target bank account, a target overseas main account, and a target domestic main account, are determined according to the mapping relationship and an information item carried by the withdrawal request.

The information item carried by the withdrawal request includes at least one of the intelligent internal-connection electronic account, the identity information of the user, the store information or the bank account. A process of requesting withdrawal is as follows. The user sends a withdrawal request to the cross-border e-commerce platform through the client, and the e-commerce platform forwards the withdrawal request to the fund-splitting platform. The withdrawal request specifies the target store and the target bank account, and the target bank account refers to a domestic bank account used by the user.

After receiving the withdrawal request, the fund-splitting platform queries mapping table based on the target store and the target bank account, so that the target intelligent internal-connection electronic account, the target store, the target bank account, the target overseas main account, and the target domestic main account are determined. The fund-splitting platform feeds the target store back to the cross-border e-commerce platform.

It should be noted that in a case that the domestic main account is mapped to the intelligent internal-connection electronic account, the identity information of the user, the store information, the bank account, and the overseas main account through the dynamic binding relationship, the mapping table is queried based on the target store and the target bank account, to determine the target intelligent internal-connection electronic account, the target store, the target bank account, the target overseas main account and the target domestic main account. In practice, determining the target domestic main account includes following steps. One of the domestic main accounts that are in the dynamic binding relationship is selected, according to the mapping relationship, as the target domestic main account. Then, the dynamic binding relationship is switched to the static binding relationship. After a fund is transferred, the static binding relationship is automatically switched back to the dynamic binding relationship. In one embodiment, a principle based on an amount of a settlement fee may be used, to select a domestic main account with the minimum settlement fee. The settlement fee mainly includes a settlement operation charge and an exchange loss in settlement. Based on the principle of the minimum settlement fee, it can be ensured that a fund (hereinafter an actual fund-splitting amount) withdrawn by the user is highest.

In the step S4, a cross-border transaction amount of the target store is transferred into the target overseas main account, and a virtual transaction fund that is equal to the cross-border transaction amount is recorded into the target intelligent internal-connection electronic account.

The cross-border e-commerce platform communicates with a financial platform, and transfers the cross-border transaction amount of the target store into the target overseas main account.

The fund-splitting platform record the virtual transaction fund that is equal to the cross-border transaction amount into the target intelligent internal-connection electronic account. The cross-border transaction amount is a sum of cross-border transaction funds of the target store. It should be noted that the virtual transaction fund is in a kind of a bill, which may be configured to record a sum of transaction amounts only, or serve as a virtual currency that can circulate on the fund-splitting platform.

In step S5, an actual fund-splitting amount is calculated based on the virtual transaction fund in the target intelligent internal-connection electronic account, the actual fund-splitting amount is transferred into the target bank account from the target domestic main account, and the target intelligent internal-connection electronic account is cleared.

The fund-splitting platform calculates the actual fund-splitting amount based on the virtual transaction fund of the intelligent internal-connection electronic account. Then, a target domestic main account with a lowest fund-splitting operation charge is selected to transfer the actual fund-splitting amount to the target bank account. Further, the sum of virtual transaction amount in the intelligent internal-connection electronic account is cleared for future usage.

In another embodiment, the user may specify a withdrawal amount of the withdrawal request when sending the withdrawal request to the cross-border e-commerce platform. In such case, after receiving the withdrawal request, the fund-splitting platform firstly calculates a total transaction amount of the target store based on transfer records in the account of the target store, and then compares the specified withdrawal amount with the total transaction amount. In a case that the specified withdrawal amount is less than or equal to the total transaction amount, the fund-splitting platform records the virtual transaction fund that is equal to the specified withdrawal amount into the target intelligent internal-connection electronic account in the step S4. Further, the fund-splitting platform returns a remaining transaction amount to the target store via the overseas main account, and clears the intelligent internal-connection electronic account in the step S5. In a case that the specified withdrawal amount is larger than the total transaction amount, the fund-splitting platform sends to the client a prompt that the total transaction amount for the target intelligence internal-connection electronic account is inadequate.

It should be noted that in practice, the target domestic main account may not be able to receive the transaction amount transferred from the target overseas main account in time. Therefore, a manner of cross-border withdrawal may be selected according to an actual situation. In one manner, the cross-border withdrawal in the step S5 is performed after the transaction fund is received by the target overseas main account and received by the target domestic main account from the target overseas main account. In another manner, payment is advanced so as to shorten a period for arrival at the user's domestic bank account. The step S5 is performed on the transaction amount being received by the target overseas main account, without waiting for the target domestic main account receiving the transaction amount.

In the method for cross-border fund-splitting according to theses embodiments, the intelligent internal-connection electronic account is configured through the fund-splitting platform, and the intelligent internal-connection electronic account are mapped to the user information through the fund-splitting platform. After a cross-border accounting period of the cross-border e-commerce platform ends, receivables of the user on the cross-border e-commerce platform are first settled to the overseas main account, then the equivalent virtual transaction fund is settled to the intelligent internal-connection electronic account of each user on the fund-splitting platform, and finally the virtual transaction fund is settled to the domestic bank account of the user after currency exchange. Therefore, it is not necessary for each merchant engaged in cross-border e-commerce to visit the overseas bank counter to open an overseas bank account. Only a unified overseas main account is required to be set in an overseas bank by the fund-splitting platform, and foreign currency payment received by the cross-border e-commerce platform is exchanged, and received by the domestic account. Avoided is a complicated problem that the user must visit the overseas bank branch counter to open an account. Further, foreign currency may be exchanged in advance via the domestic main account and settled to the domestic bank account of the user, and thereby arrival time of the fund is shortened.

### Second Embodiment

Based on the method for cross-border fund-splitting of the first embodiment, a fund-splitting platform for cross-border fund-splitting based on the intelligent internal-connection electronic account is provided. The fund-splitting platform in this embodiment can achieve cross-border withdrawal for a user. In one embodiment, the fund-splitting platform acquires an cross-border withdrawal request of the user, records a virtual transaction fund into an intelligent internal-connection electronic account, then calculates through a domestic main account an actual fund-splitting amount for the user after exchanging the virtual transaction fund, and transfers the actual fund-splitting amount to a target bank account of the user. Avoided is a complicated problem that a merchant must visit an overseas branch counter of a bank to open a bank account.

In order to achieve the aforementioned cross-border fund-splitting withdrawal, following prerequisites are required for an operator of the fund-splitting platform in this embodiment. An overseas main account and a domestic main account are registered. It is necessary for the operator to register the overseas main account and the domestic main account at a branch counter of an overseas bank and a branch counter of a domestic bank. In addition, in order to meet demands of different users and different requirements of cross-border e-commerce platforms, the operator may register multiple overseas main accounts and multiple domestic main accounts at branches of multiple overseas banks and multiple domestic banks.

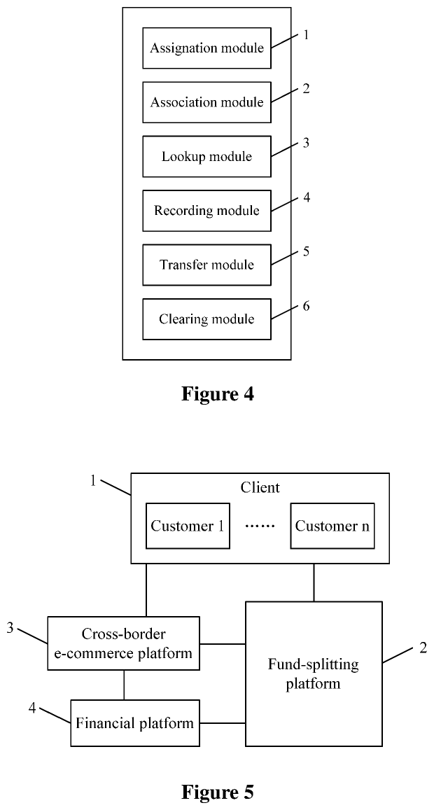

After the aforementioned overseas main account and domestic main account are successfully registered, withdrawal of the cross-border transaction amount from the cross-border e-commerce platform may be realized by the fund-splitting platform. In one embodiment, a schematic diagram of the fund-splitting platform is shown in FIG. 4.

In one embodiment, the fund-splitting platform implements network communication with external devices via a built-in server. In order to enhance stability of the network communication, the fund-splitting platform configures an overseas server and a domestic server in one embodiment. To implement a function of withdrawal, the fund-splitting platform includes an assignation module 1, an association module 2, a lookup module 3, a recording module 4, a transfer module 5 and a clearing module 6. The assignation module 1 receives a registration request from a client, assigns an intelligent internal-connection electronic account to a corresponding user, and feeds the intelligent internal-connection electronic account back to the client. The registration request carries identity information of the user, store information and a bank account. A specific operation manner of the assignation module 1 refers to the step S1 in the first embodiment.

The association module 2 associates the intelligent internal-connection electronic account, the identity information of the user, the store information, the bank account, with a pre-acquired overseas main account and a pre-acquired domestic main account, to form a mapping relationship. The domestic main account is mapped to the intelligent internal-connection electronic account, the identity information of the user, the store information, the bank account and the overseas main account, through a static binding relationship or/and a dynamic binding relationship. Details of the mapping relationship in this embodiment refer to the step S2 in the first embodiment.

The lookup module 3 receives a withdrawal request from the client, and determines a target intelligent internal-connection electronic account, a target store, a target bank account, a target overseas main account, and a target domestic main account, according to the mapping relationship and an information item carried by the withdrawal request. Determining the target domestic main account includes following steps. One of the domestic main accounts that are in the dynamic binding relationship is selected based on the mapping relationship as the target domestic main account. A binding relationship between the target domestic main account and other information items is switched to the static binding relationship.

The recording module 4 records a virtual transaction fund, which is equal to a cross-border transaction amount transferred into the target overseas main account, into the target intelligent internal-connection electronic account.

The transfer module 5 calculates an actual fund-splitting amount based on the virtual transaction fund, transfers the actual fund-splitting amount into the target bank account from the target domestic main account. A specific operation manner of the transfer module 5 refers to the step S5 in the first embodiment.

The clearing module 6 clears the target intelligent internal-connection electronic account, after the transfer module 5 finishes transfer.

It should be noted that operation of the assignation module 1, the association module 2, the lookup module 3, the recording module 4, the transfer module 5 and the clearing module 6 follows a temporal sequence in one embodiment. For example, the assignation module 1 is first operated, and other operations are not performed until the assignation module 1 assigns the intelligent internal-connection electronic account to the corresponding user. The lookup module 3 determines the target intelligent internal-connection electronic account, the target store, the target bank account, the target overseas main account, and the target domestic main account on a basis of the information item carried by the withdrawal request and the mapping relationship formed by the association module 2. It can be seen that operation of the association module 2 is earlier than operation of the lookup module 3. Similarly, calculation and transfer of the transfer module 5 is based on the virtual transaction fund recorded in the intelligent internal-connection electronic account, and thus operation of the recording module 4 is earlier than operation of the transfer module 5.

In another embodiment, in a case that the withdrawal request of the client carries a specified withdrawal amount of said withdrawal request, the recording module 4 firstly calculates a total transaction amount of the target store based on transfer records in the account of the target store, and then compares the specified withdrawal amount with the total transaction amount. In a case that the specified withdrawal amount is less than or equal to the total transaction amount, the recording module 4 records the virtual transaction fund that is equal to the specified withdrawal amount into the target intelligent internal-connection electronic account, and the transfer module 5 returns a remaining transaction amount to the target store via the overseas main account. Further the intelligent internal-connection electronic account is cleared. In a case that the specified withdrawal amount is larger than the total transaction amount, the transfer module 5 sends to the client a prompt that the total transaction amount for the target intelligence internal-connection electronic account is inadequate.

Further, there are two manners for the transfer module 5 to transfer the actual fund-splitting amount to the target bank account. In one manner, payment is advanced so as to shorten a period for fund arrival at the user's domestic bank account. The transfer module 5 transfers the actual fund-splitting amount to the target bank account via the target domestic main account, on the target overseas main account receiving the cross-border transaction amount of the target store and before the target domestic main account receiving the cross-border transaction amount. Namely, the transfer module can transfer without waiting for the target domestic account receiving the transaction amount. In another manner, the transfer module 5 transfers the actual fund-splitting amount to the target bank account via the target domestic main account, after the target overseas main account receiving the cross-border transaction amount of the target store and the target domestic main account receiving the cross-border transaction amount. Any of the above withdrawal manners may be selected according to an actual demand when the user performs the cross-border withdrawal.

Details of composition of the ID, assignation of the intelligent internal-connection electronic account, the overseas main account, the domestic main account, and the mapping relationship between the information items refer to the first example. The user can withdraw a cross-border transaction fund by the fund-splitting platform in this embodiment. In addition, the fund-splitting platform may pay in advance upon the withdrawal request, and thereby efficiency of cross-border transaction withdrawal is improved.

### Three Embodiment

Based on the first embodiment, a cross-border fund-splitting system based on an intelligent internal-connection electronic account is provided. A schematic diagram is as shown in FIG. 5. The cross-border fund-splitting system includes a client 1, a fund-splitting platform 2, a cross-border e-commerce platform 3, and a financial platform 4. The client 1 is connected in network communication the cross-border e-commerce platform 3 and the fund-splitting platform. The fund-splitting platform 2 is further connected in network communication with the financial platform 4. The cross-border e-commerce platform 3 is connected in network communication with the financial platform 4. Hereinafter operation processes of the client 1, the fund-splitting platform 2, the cross-border e-commerce platform 3 and the financial platform 4 are briefly described. A detailed operation process refers to the steps S1 to S5 in the first embodiment.

The cross-border fund-splitting system in this embodiment corresponds to the method for cross-border fund-splitting in the first embodiment. Details refer to the first embodiment. It is not necessary for a user does to visit an overseas branch counter of a bank to open an overseas bank account, and the cross-border transaction amount can be withdrawn via the cross-border fund-splitting system in this embodiment. A specific operation of the cross-border fund-splitting system in this embodiment is as follows.

The cross-border e-commerce platform 3 receives a withdrawal request from the client 1 and sends the withdrawal request to the fund-splitting platform 2. The cross-border e-commerce platform may be an e-commerce platform such as eBay or Amazon.

The fund-splitting platform 2 receives a registration request of the client 1, assigns an intelligent internal-connection electronic account to the client 1 and feeds the intelligent internal-connection electronic account back to the client 1. The registration request of the client 1 carries identity information of the user, store information and a bank account. The fund-splitting platform 2 associates the intelligent internal-connection electronic account, the identity information of the user, the store information, and the bank account, p with a pre-acquired overseas main account and a pre-acquired domestic main account, to form a mapping relationship. In withdrawal of the cross-border transaction amount by the user, the user submits a withdrawal request to the e-commerce platform 3 via the client. The cross-border e-commerce platform 3 receives the withdrawal request of the client 1, and sends the withdrawal request to the fund-splitting platform 2. The fund-splitting platform 2 receives the withdrawal request from the client, and determines a target intelligent internal-connection electronic account, a target store, a target bank account, a target overseas main account, and a target domestic main account, according to the mapping relationship and the information item carried by the withdrawal request. The information item carried by the withdrawal request includes at least one of the intelligent internal-connection electronic account, the identity information of the user, the store information, and the bank account. The fund-splitting platform 2 feeds the target store back to the cross-border e-commerce platform 3. The cross-border e-commerce platform 3 further communicates with the financial platform 4, and transfers a cross-border transaction amount of the target store to the target overseas main account. The fund-splitting platform 2 records a virtual transaction fund, which is equal to the cross-border transaction amount, into the target intelligent internal-connection electronic account. The fund-splitting platform 2 calculates an actual fund-splitting amount based on the virtual transaction fund in the target intelligent internal-connection electronic account, transfers the actual fund-splitting amount to the target bank account from the target domestic main account, and clears the target intelligent internal-connection electronic account.

In another embodiment, the user may specify a withdrawal amount of the withdrawal request when sending the withdrawal request to the cross-border e-commerce platform. In such case, after receiving the withdrawal request, the fund-splitting platform 2 firstly calculates a total transaction amount of the target store based on transfer records in the account of the target store, and then compares the specified withdrawal amount with the total transaction amount. In a case that the specified withdrawal amount is less than or equal to the total transaction amount, the fund-splitting platform 2 records the virtual transaction fund that is equal to the specified withdrawal amount into the target intelligent internal-connection electronic account. Further, the fund-splitting platform 2 returns a remaining transaction amount to the target store via the overseas main account, and clears the intelligent internal-connection electronic account. In a case that the specified withdrawal amount is larger than the total transaction amount, the fund-splitting platform 2 sends to the client a prompt that the total transaction amount for the target intelligence internal-connection electronic account is inadequate.

In one embodiment, the fund-splitting platform 2 includes an assignation module, an association module, a lookup module, a recording module, a transfer module, and a clearing module. The assignation module receives the registration request from the client, assigns an intelligent internal-connection electronic account to the corresponding user, and feeds the intelligent internal-connection electronic account back to the client. The registration request carries the identity information of the user, the store information and the bank account. A specific operation manner of the assignation module refers to the step S1 in the first embodiment.

The association module associates the intelligent internal-connection electronic account, the identity information of the user, the store information, and the bank account, with the pre-acquired overseas main account and the pre-acquired domestic main account, to form the mapping relationship. A specific mapping relationship refers to the step S2 in the first embodiment.

The lookup module receives the withdrawal request of the client, and determines the target intelligent internal-connection electronic account, the target store, the target bank account, the target overseas main account, and the target domestic main account, according to the mapping relationship and the information item carried by the withdrawal request.

The recording module records the virtual transaction fund, which is equal to the cross-border transaction amount transferred into the target overseas main account, into the target intelligent internal-connection electronic account.

The transfer module calculates the actual fund-splitting amount based on the virtual transaction fund, and transfers the actual fund-splitting amount into the target bank account from the target domestic main account. A specific operation manner of the transfer module refers to the step S5 in the first embodiment.

The clearing module clears the target intelligent internal-connection electronic account, after the transfer module finishes transfer.

Further, there are two manners for the transfer module to transfer the actual fund-splitting amount to the target bank account. In one manner, payment is advanced so as to shorten a period for fund arrival at the user's domestic bank account. The transfer module transfers the actual fund-splitting amount to the target bank account via the target domestic main account, on the target overseas main account receiving the cross-border transaction amount of the target store and before the target domestic main account receiving the cross-border transaction amount. Namely, the transfer module can transfer without waiting for the target domestic account receiving the transaction amount. In another manner, the transfer module transfers the actual fund-splitting amount to the target bank account via the target domestic main account, after the target overseas main account receiving the cross-border transaction amount of the target store and the target domestic main account receiving the cross-border transaction amount. Any of the above withdrawal manners may be selected according to an actual demand when the user performs the cross-border withdrawal.

The fund-splitting platform 2 can transfer domestically transfer after the target overseas main account receives the cross-border transaction amount of the target store, regardless of whether the target domestic main account receives the cross-border transaction amount. Thereby, domestic transfer-in and overseas transfer-out are separately handled for the cross-border fund-splitting system in this embodiment. Efficiency of business processing is improved in the cross-border fund-splitting system.

### Fourth Embodiment

The first embodiment, the second embodiment and the third embodiment have a same object that the user can withdraw the cross-border transaction amount without visiting an overseas branch counter of an overseas bank to open an overseas bank account. In this embodiment, a payment platform is further provided on the basis of the first embodiment, the second embodiment and the third embodiment. The fund-splitting platform in the second embodiment is directly integrated into the payment platform in this embodiment. The fund-splitting platform serves as an integrated module in the payment platform, and the intelligent internal-connection electronic account assigned by the fund-splitting platform serves as an account of the user on the payment platform. By using the intelligent internal-connection electronic account, the user can perform payment operations, such as overseas collection and overseas paying, and process fund-splitting through the payment platform. Thereby, addressed is a problem that cross-border transactions cannot be performed or the cross-border transaction is complicated on a conventional third-party payment platform.

Hereinabove the present disclosure is described by using embodiments, which are merely intended to help understand the present disclosure instead of limiting the present disclosure. Those skilled in the art to which the present disclosure pertains can make simple derivations, variations, or substitutions in accordance with the concept of the present disclosure.

1. A method for cross-border fund-splitting based on an intelligent internal-connection electronic account, comprising:
receiving a registration request from a client, wherein the registration request carries identity information of the user, store information, and a bank account;
assigning an intelligent internal-connection electronic account to a corresponding user;
feeding the intelligent internal-connection electronic account back to the client;
associating the intelligent internal-connection electronic account, the identity information of the user, the store information, and the bank account, with a pre-acquired overseas main account and a pre-acquired domestic main account, to form a mapping relationship;
receiving a withdrawal request from the client;
determining a target intelligent internal-connection electronic account, a target store, a target bank account, a target overseas main account, and a target domestic main account, according to the mapping relationship and an information item carried by the withdrawal request, wherein the information item carried by the withdrawal request comprises at least one of the intelligent internal-connection electronic account, the identity information of the user, the store information, or the bank account;
transferring a cross-border transaction amount of the target store into the target overseas main account;
recording a virtual transaction fund that is equal to the cross-border transaction amount into the target intelligent internal-connection electronic account, or, recording a virtual transaction fund that is equal to a predetermined withdrawal amount into the target intelligent internal-connection electronic account when there is the predetermined withdrawal amount in the withdrawal request;
calculating an actual fund-splitting amount based on the virtual transaction fund in the target intelligent internal-connection electronic account;
transferring the actual fund-splitting amount into the target bank account from the target domestic main account; and
clearing the target intelligent internal-connection electronic account.

2. The method for cross-border fund-splitting according to claim 1, wherein the actual fund-splitting amount is transferred into the target bank account from the target domestic main account, on the target overseas main account receiving the cross-border transaction amount of the target store and before the target domestic main account receiving the cross-border transaction amount.

3. The method for cross-border fund-splitting according to claim 1, wherein the actual fund-splitting amount is transferred into the target bank account from the target domestic main account, after the target overseas main account receiving the cross-border transaction amount of the target store and the target domestic main account receiving the cross-border transaction amount.

4. The method for cross-border fund-splitting according to claim 1, wherein the domestic main account is mapped to the intelligent internal-connection electronic account, the identity information of the user, the store information, the bank account, and the pre-acquired overseas main account, through one or both of a statistic binding relationship and a dynamic binding relationship.

5. The method for cross-border fund-splitting according to claim 4, wherein:
the domestic main account is mapped to the intelligent internal-connection electronic account, the identity information of the user, the store information, the bank account, and the pre-acquired overseas main account through the dynamic binding relationship; and
determining the target domestic main account in determining the target intelligent internal-connection electronic account, the target store, the target bank account, the target overseas main account, and the target domestic main account, according to the mapping relationship and an information item carried by the withdrawal request, comprises:
selecting one from domestic main accounts that are in the dynamic binding relationship, of the mapping relationship, as the target domestic main account; and
switching the target domestic main account to be mapped to other information items through the static binding relationship.

6. A fund-splitting platform based on an intelligent internal-connection electronic account, comprising:
an assignation module, configured to receive a registration request from a client, assign an intelligent internal-connection electronic account to a corresponding user, and feed the intelligent internal-connection electronic account back to the client, wherein the registration request carries identity information of the user, store information and a bank account;
an association module, configured to associate the intelligent internal-connection electronic account, the identity information of the user, the store information, the bank account, with a pre-acquired overseas main account and a pre-acquired domestic main account, to form a mapping relationship;
a lookup module, configured to receive a withdrawal request from the client, and determine a target intelligent internal-connection electronic account, a target store, a target bank account, a target overseas main account, and a target domestic main account, according to the mapping relationship and an information item carried by the withdrawal request, wherein the information item carried by the withdrawal request comprises at least one of the intelligent internal-connection electronic account, the identity information of the user, the store information, or the bank account;
an recording module, configured to:
record a virtual transaction fund, which is equal to a cross-border transaction amount transferred into the target overseas main account, into the target intelligent internal-connection electronic account, or
record a virtual transaction fund, which is equal to a predetermined withdrawal amount in the withdrawal request, into the target intelligent internal-connection electronic account;
a transfer module, configured to calculate an actual fund-splitting amount based on the virtual transaction fund, and transfer the actual fund-splitting amount into the target bank account from the target domestic main account; and
a clearing module, configured to clear the target intelligent internal-connection electronic account.

7. The fund-splitting platform according to claim 6, wherein the transfer module transfers the actual fund-splitting amount into the target bank account from the target domestic main account, on the target overseas main account receiving the cross-border transaction amount of the target store and before the target domestic main account receiving the cross-border transaction amount.

8. The fund-splitting platform according to claim 6, wherein the transfer module transfers the actual fund-splitting amount into the target bank account from the target domestic main account, after the target overseas main account receiving the cross-border transaction amount of the target store and the target domestic main account receiving the cross-border transaction amount.

9. The fund-splitting platform according to claim 6, wherein the domestic main account is mapped to the intelligent internal-connection electronic account, the identity information of the user, the store information, the bank account, and the pre-acquired overseas main account, through one or both of a statistic binding relationship and a dynamic binding relationship.

10. A payment platform, wherein the fund-splitting platform according to claim 6 is integrated in the payment platform.

11. A payment platform, wherein the fund-splitting platform according to claim 7 is integrated in the payment platform.

12. A payment platform, wherein the fund-splitting platform according to claim 8 is integrated in the payment platform.

13. A payment platform, wherein the fund-splitting platform according to claim 9 is integrated in the payment platform.
